(19) United States
(12) Patent Application Publication
(10) Pub. No.: US 2007/0231481 A1
(43) Pub. Date: Oct. 4, 2007

(54) Method for manufacturing decorative stone

(75) Inventor: Yu Zheng, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: CARDINY STONE (SHENZHEN) CO., LTD., Shenzhen (CN)

(21) Appl. No.: 11/484,138

(22) Filed: Jul. 11, 2006

(30) Foreign Application Priority Data
Mar. 29, 2006 (CN) 200610060112.1

(51) Int. Cl. B05D 7/22; B05D 3/12

(52) U.S. Cl. 427/230; 427/289

(57) ABSTRACT

A method for manufacturing a decorative stone comprises steps of: non-through cutting a stone tile to a predetermined depth according to a predesigned pattern by the ultrasonic or water jet; mixing a color material for filling the cutting lines; and filling the mixed color material into the cutting lines, then the contour of the predesigned pattern is obviously visualized. In accordance with the present invention, a predesigned pattern is non-through cut in a stone tile by modern technologies, and then inlaid with decorative materials so that a decorative stone is achieved with increased decorative effect.

### BACKGROUND OF THE INVENTION

1. Field of the Invention

The present invention relates to a field of building stone, and more especially to a method for manufacturing a decorative stone.

2. Background of the Invention

A decorative stone is one type of building stones which has function of decoration and can be used for architectural decoration or furniture tops. Conventionally, the method of cutting a decorative stone is by a diamond disk saw or a diamond wire saw. Due to the restriction of the specificity of the cutting tool and the work piece, the work piece could not be machined accurately during manufacturing. The known machine pattern also fails to machine the work piece as various predetermined shapes without penetrating the work piece.

Ultrasonic cutting technologies are increasingly used for cutting stones. One of them is an ultrasonic cutting tool which creates ultrasonic vibration by imposing voltage on a ceramic vibrator. After that, the ultrasonic vibration is amplified to be forty thousand times per second on the tool head. Abrasives are added between the cutting tool and the work piece, which make the cutting more easily.

The art of the stone inlay was used even in the ancient India, but by far this art is embodied by manual work none the less. However, it is of course not ensured that each product of each-time production is identical to another, so this art is unable to be industrialized, and the manufacturer using this way can not have mass production based on the identical design of the order form in modern commercial distribution field.

Putting some patterns on the surface of a decorative stone is also a tradition method of increasing the decorative effect. Conventionally, the pattern is printed on the surface of the decorative stone, which is easily to be frayed and flake off. Especially when the decorative stone is exposed, the pattern is more easily to be frayed and flake off, and inversely affects the decorative function.

### BRIEF SUMMARY OF THE INVENTION

A primary object of the present invention is to provide a method for manufacturing a decorative stone which increases the decorative effect through non-through cutting a predesigned pattern and filling a color material into the cutting lines.

To achieve the above-mentioned object, a method for manufacturing a decorative stone comprises steps of: non-through cutting a stone tile to a predetermined depth according to a predesigned pattern by the ultrasonic cutting technology or water jet technology; mixing a color material for filling the cutting lines; and filling the mixed color material into the cutting lines, then the contour of the predesigned pattern is obviously visualized.

In accordance with the present invention, a predesigned pattern is non-through cut in a stone tile, and filled with decorative materials so that a decorative stone is achieved with increased decorative effect and provides for a wide range of ornamental and architectural uses. The predesigned pattern formed in the stone tile by this method is durable and not easily to be frayed and flake off. It also keeps the decorative stone smooth through inlaying the pattern therein. Furthermore, this manufacturing method is able to be industrialized with the use of ultrasonic technology or water jet technology.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic view showing a decorative stone in accordance with the preferred embodiment of the present invention, which includes a plurality of cutting lines with decorative materials filled therein.

### DETAILED DESCRIPTION OF THE INVENTION

A method for manufacturing a decorative stone in accordance with a preferred embodiment of the present invention includes steps as follows:

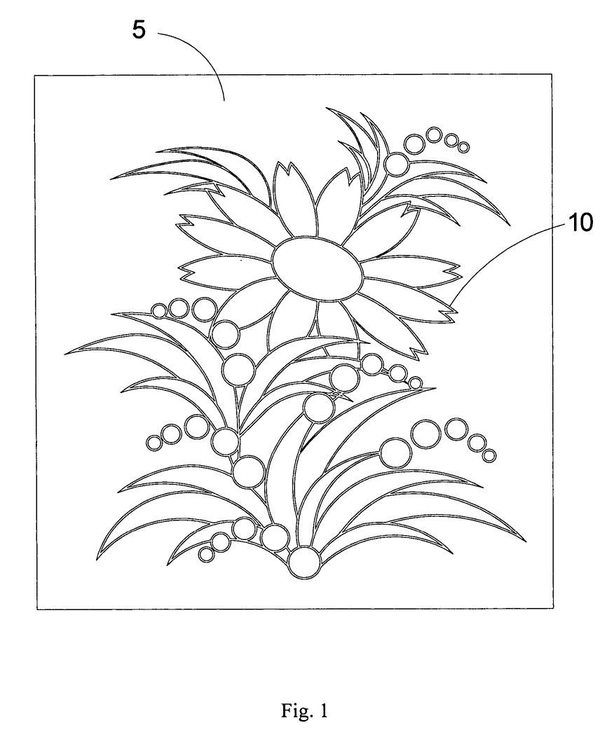

At the step 1, referring to FIG. 1, non-through cutting a stone tile to a predetermined depth according to a predesigned pattern by the ultrasonic cutting technology or water jet technology. The predetermined cutting depth is based on different designs as well as the thickness of the stone tile. After said cutting process, the predetermined pattern is shown by the cutting lines.

Then turn to the step 2, mixing a color material for filling the cutting lines. The color material comprises at least one of various color glutinous materials, or a mixture of stone powder and adhesive. The adhesives can be unsaturated epoxy resin or polyurethane adhesive, and so on. The stone powder can be at least one kind of materials among marble powder, quartzite powder, granite powder, and alumina powder.

At the step 3, filling the mixed color material into the cutting lines. Then a contour of the predesigned pattern is obviously visualized.

As shown in FIG. 1, a decorative stone is achieved according to the manufacturing method in accordance with the present invention, the mainbody of the decorative stone is a stone tile 5, and a plurality of non-through cutting lines 10 is formed therein. The depth of the plurality of non-through cutting lines 10 is about several millimeters, such as from 2 mms to 3 mms. The plurality of non-through cutting lines 10 forms a contour of a plant. A color material is filled in the cutting lines 10, which includes at least one of various color glutinous materials, or a mixture of stone powder and the adhesive that can cohere stone powder. The adhesive comprises unsaturated epoxy resin or polyurethane adhesive, and so on. The stone powder comprises at least one kind of materials among marble powder, quartzite powder, granite powder, and alumina powder. In this embodiment, the predesigned pattern for cutting is a plant shape, in other embodiments, it can be various patterns for increasing the decorative effect of the stone tile 5.

Advantageously, it is preferred to choose a sandwich stone tile such as stone-stone, stone-ceramic tile, stone-fiberglass, stone-aluminum plastic, stone-metal, stone-aluminum honeycomb, stone-composite material or the like to manufacture the stone tile 5. The sandwich stone tile is made by a combination of a thin layer of stone (from 2 mms to 8 mms) and another layer of base material sticked together. The sandwich stone tile has some advantages just like acid & alkaline resistance, high intensity and little chromatic aberration. The benefit of choosing the sandwich stone tile lies in that the cutting becomes easier and more fluent because of structural properties of the type of tile.

In accordance with the present invention, it could adopt different color materials for filling the cutting lines so as to achieving various visual effects.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a decorative stone comprising steps of:
non-through cutting a stone tile to a predetermined depth according to a predesigned pattern by the ultrasonic or water jet;
mixing a color material for filling the cutting lines; and
filling the mixed color material into the cutting lines.

2. The method as claimed in claim 1, wherein the color material comprises color glutinous material.

3. The method as claimed in claim 1, wherein the color material comprises a mixture of stone powder and adhesive, and the adhesive comprises the adhesive that can cohere stone powder together, or adhesive filling material and mixed filling material.

4. The method as claimed in claim 3, wherein the adhesive that can cohere stone powder together comprises unsaturated epoxy adhesive and polyurethane.

5. The method as claimed in claim 3, wherein the stone powder comprises at least one kind of materials among marble powder, quartzite powder, granite powder, and alumina powder.
